(19) United States
(12) Patent Application Publication
(10) Pub. No.: US 2025/0013913 A1
(43) Pub. Date: Jan. 9, 2025

(54) SYSTEM AND METHOD FOR MACHINE LEARNING MODEL RE-FORMULATION

(71) Applicant: Microsoft Technology Licensing, LLC, Redmond, WA (US)

(72) Inventors: Laurent BOUÉ, Petah Tikya (IL); Kiran RAMA, Bangalore (IN)

(21) Appl. No.: 18/347,967

(22) Filed: Jul. 6, 2023

(51) Int. Cl. G06N 20/00

(52) U.S. Cl. CPC G06N 20/00

(57) ABSTRACT

A computerized method for determining when an ML model in a data generation process is not stable is described. An original set of training data is applied to each ML model in a data generation process. Loss values are determined from data samples from each of the ML models. The average distance between the data samples that have a difference in loss value less than a threshold are determined for each of the ML models. The dependency rate of separation between the average distances are analyzed versus the number of model runs as an exponential model. Based on the analyzing, it is determined whether the ML models are stable or divergent.

### BACKGROUND

Machine learning (ML) models are used in a variety of applications to analyze data and make predictions or decisions. ML models are trained to learn patterns and relationships from the data and generalize that knowledge to new, unseen instances. During training, the ML models adjust internal parameters to minimize a difference between predicted and actual outputs. Ensuring the ML models are current is very important to product performance.

Retraining an ML model can be performed periodically, or based on a variety of factors, such as pre-defined cadence or drop in the ML model performance. However, the main goal of retraining the ML model is to keep the ML models up to date with whatever form of data/concept drift an ML solution may be affected by. In almost every conventional retraining procedure, the retraining procedure collects new (i.e. more recent) training data and restarts the ML training procedure (either as fine-tuning from the previous model or from scratch). However, training models too frequently can affect stability as well as additional compute and overhead costs. Nonetheless, the underlying assumptions that were made during initial development of the ML model (such as feature engineering, choice of architecture, and target variables) remain unchanged as the ML models are being retrained.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Example solutions for determining a stability of a data generation process for machine learning (ML) models include: identifying, from a first set of loss values for a first ML model, a first plurality of training sample pairs from a first set of training samples that have a difference in a loss value less than a threshold; identifying, from the second set of data, a second plurality of training sample pairs that correspond to the first plurality of training sample pairs, the second set of data comprising a second set of loss values for the first set of training samples applied to a second ML model that was trained using a second set of training samples; determining, from the first set of loss values, a first average loss value distance between each pair from the first plurality of training sample pairs from the first set of training samples; determining, from the second set of loss values, a second average loss value distance between each pair from the second plurality of training sample pairs; analyzing, as an exponential model, a dependency of a rate of separation between the first average loss value distance and the second average loss value distance versus a number of model runs; based on the analyzing, determining whether the training of the second ML model using the second set of data training samples is stable; and causing the first ML model to be reformulated when the second ML model is not stable.

### BRIEF DESCRIPTION OF THE DRAWINGS

The present description will be better understood from the following detailed description read considering the accompanying drawings, wherein:

FIG. 1 is a block diagram illustrating an example system in accordance with some embodiments;

FIG. 2 is a flowchart illustrating an example method for determining loss values for an initial ML model.

FIG. 3 is a flowchart illustrating an example method for determining loss values for a subsequent ML model using original training data.

FIG. 4 is a flowchart illustrating an example method for determining a stability of a data generation process;

FIG. 5 illustrates an example computing apparatus as a functional block diagram.

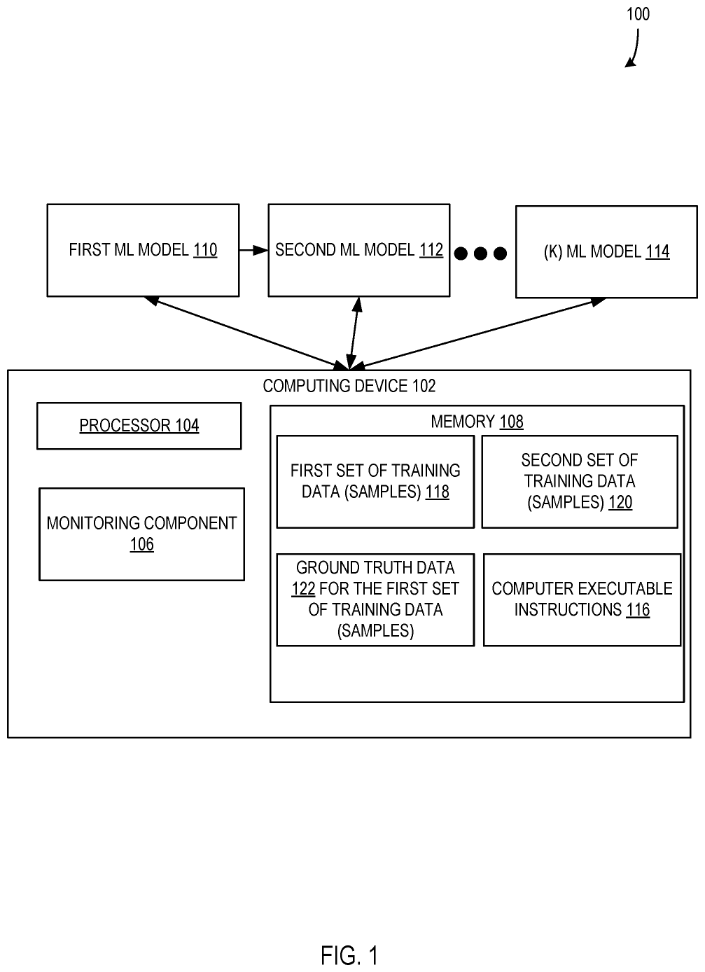

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide a system and method for determining the stability of a data generation process for machine learning (ML) models. Conventional systems only look at model re-training indicators. These indicators tell an ML scientist to re-train the ML model when there is a drift, as measured by change in input data distributions or a drop in the performance of the ML model, or a drop in real-world data performance. In these instances, the ML model is retrained using a current set of training data. However, what these systems fail to provide is an ability to determine if the ML model itself should be reformulated, not simply retrained.

For example, data drift is usually estimated by looking at distribution shifts in the input space which can be very high dimensional. While there are known statistical tests to assess whether data samples are drawn from different distributions, these techniques typically rely on several assumptions, such as samples independence, and the need to operate on high-dimensional data. Conventional systems and methods address the question of data/concept drift for ML models and have strategies to determine optimal retraining strategies for these ML models. However, unlike conventional systems, the systems described herein provide the ability to identify situations in which retraining (no matter what the strategy is) does not resolve an underlying problem with the ML model, and thus, the ML model should be reformulated.

The disclosure operates in an unconventional manner at least by identifying when a data generating process is divergent (e.g., not stable) and thus a reformulation of the ML model is needed to ensure optimal performance. That is, by applying an original data set (the data set used to train a first ML model) to each subsequent ML model and evaluating the loss values that stem therefrom, the systems described herein can take proactive actions to prevent a negative impact a non-stable data generation process has by retraining the ML model, and instead, reformulate the ML model.

The systems and methods described herein can be integrated as a feature in data/concept drift monitoring systems to raise alerts about efficiency limitations of retraining strategies. The method to determine whether the data generating process is stable under a current ML formulation is independent of any retraining strategy adopted by conventional systems and methods and thus can be applied to existing and future retraining strategies. The systems and methods herein use loss values of iterative trained ML models as a proxy that captures a drift by adapting its weights to better model the data. Further, since loss functions reduce from high-dimensional space to a single scalar value, a need to handle high compute/memory requirements associated with high-dimensional vectors is removed.

Accordingly, the system and methods described herein address an inherently technical problem of accurately and efficiently determining when a data generating process for iteratively trained ML models is no longer stable and provides a technical solution by pro-actively taking action to cause a reformation of the ML model and prevent additional ML models from being retrained under the current data generation process. As such, the systems and methods described herein provide a data generation process that is more accurate, uses less compute resources, is more efficient, and is faster than conventional data generation systems and methods. In addition, the systems and methods described herein address an underlying problem with an ML model in a data generation process that is considered not stable. That is, while conventional systems and methods merely manipulate parameters of the ML model to achieve best results as they can without addressing the underlying problems of the data generation process that is considered not stable, the systems and methods described herein address the underlying problems by reformulating the ML model when the ML model is determined to not be stable.

FIG. 1 is a block diagram illustrating an example system 100 configured for determining whether a data generation process for providing iterative ML models is considered not stable. The system 100 includes a computing device 102 that includes a processor 104, a monitoring component 106, and a memory 108. The memory 108 includes computer-executable instructions 116 that can be executed by the processor 104 to perform the methods described herein. In some implementations, the computer-executable instructions 116 can comprise a plurality of software and/or hardware modules that are each configured to perform, or are for performing, individual or multiple steps of the method described herein. In some examples, the memory 108 is separate from the computing device 102 and is an example of cloud storage accessible by the computing device 102 over a network. In another example, the memory 108 may be part of a separate device to the other components of the system 100.

The system 100 further includes a first ML model 110, a second ML model 112, and a K^{th} ML model 114. While the first ML model 110, the second ML model 112, and the Kth ML model 114 are shown as being separate from the memory 108, in some examples, one or more of the first ML model 110, the second ML model 112, and the K^{th} ML model 114 are stored in the memory 108. Further, in the examples described herein, the first ML model 110 is an original ML model (e.g., the first ML in the set) trained using the first set of training data 118, the second ML model 112 is a subsequent ML model retrained using the second set of training data 120, and the K^{th} ML model represents a last (or most current) ML model in the set. In some examples, the K^{th} ML model 114 is the third ML model, the 10^{th} ML model, the 100^{th} ML model, or the 1000^{th} ML model in the data generation process.

As explained above, the first ML model 110 was trained using the first set of training data 118. The first set of training data includes a set of training samples X={x1, x2, . . . }. Taking the first ML model 110 as a function “M” parametrized by a set of weights “W”, the function “M” takes the set of training samples “X” as input samples (e.g., x1, x2 . . . ) and returns a set of predictions “Y”, where Y={y1=M(x1), y2=M(x2), . . . } for each one of the input samples. The predictions “Y” are then compared against their known ground-truths Ygt={y1gt, y2gt, . . . } (e.g., from ground truths 122) and a degree of mismatch between prediction and ground-truth is quantified using a loss function “L”. As such, each sample (e.g., x1, x2 . . . ) from the training samples “X” has its own individual loss value {L(y1, y1gt), L(y2, y2gt), . . . }. In some examples, training the first ML model 110 includes tuning weights “W” of the first ML model 110, such that an average loss over all the training samples in “X” is minimized. As explained above, each sample in the first set of training data 118 is associated with a loss value. As used herein, “L1” represents the set of loss values L1={L(M1(x1), y1gt), L(M1(x2), y2gt), . . . } in the first set of training data 118.

Conventionally, when it is determined that first ML model 110 needs to be trained with a new set of training data (e.g., after a period of time or a drop in performance of the first ML model 110), the first ML model 110 is retrained using a new set of training data (e.g., the second set of training data 120), which is different that the first set of training data 118, which results in a new ML model, such as the second ML model 112. Thus, in this example, the retraining of the first ML model 110 with the second set of training data 120 results in the second ML model 112. As such, weights that are part of the second ML model 112 are different than the weights that are part of the first ML model 110 so as to better reflect the second set of training data 1120.

However, retraining an ML model may not resolve underlying issues with respect to the ML model and the data generating process the ML model is based on. That is, retraining an ML model with new training data and adjusting parameters/weights of the ML model to better model the new training data may be a temporary fix to a long term problem with the ML model, that if not addressed, makes the ML model less accurate, computationally heavy, consumes more resources to implement, and is more time consuming run. However, the system 100 described herein provides the ability to identify if/when an ML model in a data generation process is not stable, and thus needs reformations as opposed to conventional retraining.

The following examples describe how the system 100 determines if/when an ML model in a data generation process is not stable using the first ML model 110, the second ML model 112, and the K^{th} ML model 114 as iterative ML models in a data generation process. For simplicity, the process described herein uses the first ML model 110 and the second ML model 112 (e.g., only two ML models) when describing the details on how to determine whether the first ML model 110 and the second ML model 112 are stable. Thus, while the examples described herein use two ML models to describe the process, the larger number of ML models being analyzed, the more accurate the results. As such, it is understood that the number of ML models being monitored/analyzed by the monitoring component 106 can be greater than 10, or greater than 100, for example. In addition, while the second ML model 112 is shown as directly proceeding the first ML model 110 in FIG. 1, in some examples there are a number of ML models between the first ML model 110 and the second ML model 112. However, for simplicity, the second ML model 112 is described as the ML model that results from the first ML model 110 being re-trained by the second set of training data 120.

In order to determine whether the generation process, and therefore the second ML model 112 is stable or divergent, when the second ML model 112 is generated using the second set of training data 120, the monitoring component 106 also applies the first set of training data 118 (e.g., the original data training set) to the second ML model 112. Thus, from the first set of training data 118 applied to the second ML model 112, samples (e.g., x1, x2 . . . ) from the training samples “X” in the first set of training data 118 generates a new set of loss values, and “L2” represents the second set of loss values L2={L(M2(x1), y1gt), L(M2(x2), y2gt), . . . }.

As mentioned above, the process includes multiple ML models being evaluated. Thus, when a third ML model is generated (e.g., by retraining the second ML model 112 using a new third set of training data), the monitoring component 106 also applies the third ML model on first set of training data 118 to generate another set of loss values L3={L(M3(x1), y1gt), L(M3(x2), y2gt), . . . }. Carrying on this procedure after “n” re-training iterations, we end up with “N” sets of loss values for the same samples from first set of training data 118:

$$\begin{matrix}L 1 = \{ L ( M 1 ( x 1 ) , y 1 gt ) , L ( M 1 ( x 2 ) , y 2 gt ) , … \} \\ L 2 = \{ L ( M 2 ( x 1 ) , y 1 gt ) , L ( M 2 ( x 2 ) , y 2 gt ) , … \} \\ L 3 = \{ L ( M 3 ( x 1 ) , y 1 gt ) , L ( M 3 ( x 2 ) , y 2 gt ) , … \} \\ … \\ Ln = \{ L ( Mn ( x 1 ) , y 1 gt ) , L ( Mn ( x 2 ) , y 2 gt ) , … \}\end{matrix}$$

Thus, while each new ML model is trained using a new set of training data (e.g., as is conventionally done in the retraining process), the monitoring component 106 also applies each ML model to the original set of training data (e.g., the first set of training data used to train the very first ML model, the first ML model 110). Each ML model provides different results when applied to the first set of training data 118 given each ML model's weights are different at every iteration and, therefore, loss values associated with the training samples in the first set of training data 118 are also changing at every iteration (e.g., for each subsequent ML model).

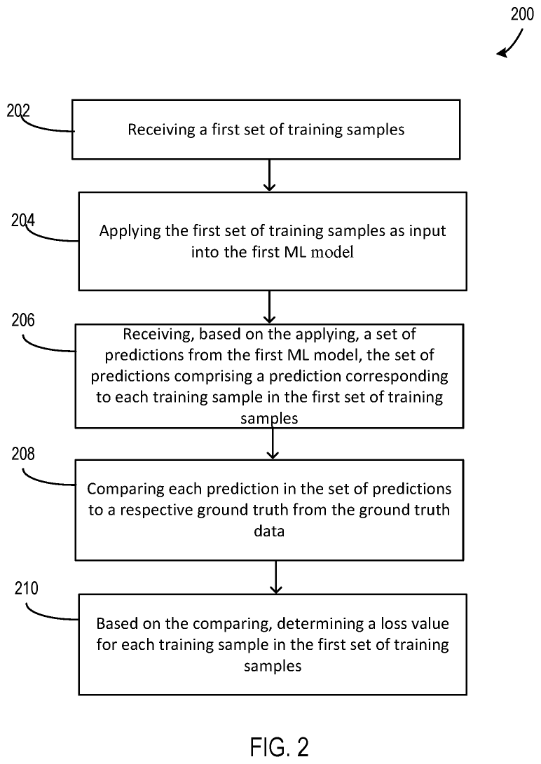

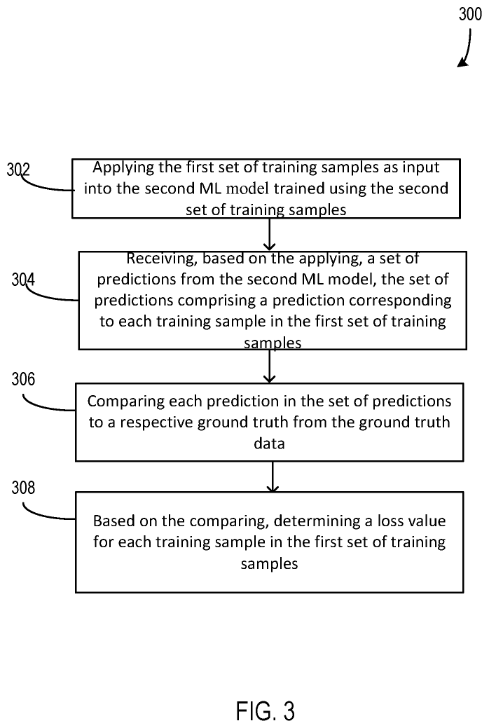

After the monitoring component 106 collects the loss values after a latest ML model is generated (which, in some examples, is performed after or in parallel with the generation of each new ML model), the monitoring component 106 executes an ML formulation stability analysis. While the techniques described herein are based on Lyapunov exponents, other formulas/equations that determine a rate of separation may also be used. Further, while the examples described herein with respect to FIG. 1 provide that the monitoring component 106 executes the operation of the process, in some examples, the monitoring component 106 causes the processor 104 to execute the computer-executable instructions 116 to perform the operations described herein (e.g., as shown in FIGS. 2 and 3).

Continuing with the ML formulation stability analysis, for each set of loss values (e.g., L1-Ln), the monitoring component 106 identifies all pairs of samples that are arbitrarily close to each other in terms of loss values (i.e., below a threshold. For example, assume that samples xi and xj from the first set of training data 118 applied to the first ML model 110 are such that |L1(xi)−L1(xj)|<eps (where the threshold is eps=1e-4). As new ML models are generated (e.g., the second ML model 112) based on the retraining of a previous ML model (e.g., the retraining of the first ML model 110 on the second set of training data 120), the loss values associated with xi and xj lead to two sequences [L1(xi), L2(xi), . . . , Ln(xi)] and [L1(xj), L2(xj), . . . , Ln(xj)]. The monitoring component 106 monitors (in real time) how these two sequences (that initially started very close to each other) eventually separate and diverge from each other as the new ML models are being retrained. After k re-trainings (e.g., after the K^{th} ML model 114 is generated), the monitoring component 106 measures a distance|Lk(xi)−Lk(xj)|. In some examples, this distance, while once small (e.g., below a particular threshold), is no longer a small eps. Number (e.g., below the threshold), but rather, may be a much larger value (e.g., greater than the threshold).

As previously explained, the monitoring component 106 takes a single pair of samples xi and xj that were initially close to each other, and also finds all the other samples from the first set of training data 118 that are also initially close to each other and average their distance after k re-trainings. In some examples, the average distance “d(k)” after “k” re-trainings is defined as follows:

$$d ( k ) = Avg \vert Lk ( xi ) - Lk ( xj ) \vert over all pairs ( i , j ) of samples such that \vert L 1 ( xi ) - L 1 ( xj ) \vert < eps .$$

In the examples above, a single pair (e.g., xi and xj) of training samples from the first set of training data samples 118 that are arbitrarily close to each other (in terms of loss values) are used. In some examples, all of the pairs of samples that are considered arbitrarily close to each other are used. In some examples, the number of pairs of samples used are greater than 50, greater than 100, or greater than 1000. In some examples, only a certain number of pairs of samples that are arbitrarily close to each other are used. In this example, the pairs of samples that are used are a pre-defined number of pairs of samples that are closest to each other. In another example, when only a certain number of pairs of samples that are arbitrarily close to each other are used (e.g., a pre-defined number), the pairs of samples are selected at random or in order of processing.

The monitoring component 106 repeats the solving of “d(k)” for a range of values of “k” (for example k=1, 2, . . . 10) and analyzes a dependency of d(k) vs. k as an exponential model d(k)˜exp(k*lambda) where lambda is a parameter which is extracted from the data itself. In some examples, when the value of lambda is equal to or less than zero, the monitoring component 106 determines that the data generating process is stable under the current ML formulation, and thus, a latest ML model (e.g., the second ML model 112 or the K^{th} ML model 114) is stable and standard model retraining strategies are enough to keep the current ML model up to date, as well as address any potential data/concept drifts. However, in some examples, when lambda is greater than 0, monitoring component 106 determines that the data generating process is divergent (e.g., not stable) and the standard model retraining strategies is determined to not be enough to keep the ML models in the data generating process up to date and is not enough to address any potential data/concept drifts. In this case, the monitoring component 106 raises an alert that the data generating process, and therefore, the ML models that stem therefrom, are not stable and re-trainings of the ML models are bound to be ultimately unsuccessful and a new formulation of the ML model is needed. In some examples, the alert is presented to a user in graphical user interface. In some examples, the alert enables the user to reformulate the ML model. In other examples, the alert disables the ability of a current ML model to be retrained. In this example, the current ML model is still used to provide data until a new ML model is generated/trained based on the reformulation.

In the context of dynamical systems/applied mathematics, lambda as used herein is referred to as a “Lyapunov” exponent, that measures a rate of separation of infinitesimally close trajectories. In the examples described herein, chaotic behavior (i.e. lambda>0) signifies that a current ML formulation is inadequate as an accurate model of the underlying data generating process. In some examples, when a retraining of the ML models happen at constant time intervals, lambda is interpreted as a typical coherence time of the data generating process under the current ML formulation.

FIG. 2 is a flowchart illustrating an exemplary method 200 for determining loss values for an initial ML model (e.g., the first ML model 110). In some examples, the method 200 is executed or otherwise performed by or in association with a system such as system 100 of FIG. 1.

At 202, samples from the first set of training data 118 is received. At 204, the samples in the first set of training data 118 are applied as input into the first ML model 110. At 206, a set of predictions are received from the first ML model 110. The set of predictions include a prediction corresponding to each training sample in the first set of training data 118. For example, the first set of training data includes the set of training samples X={x1, x2, . . . }. Taking the first ML model 110 as a function “M” parametrized by a set of weights “W”, the function “M” takes the set of training samples “X” as input samples (e.g., x1, x2 . . . ) and returns a set of predictions “Y”, where Y={y1=M(x1), y2=M(x2), . . . } for each one of the input samples. At 208, each prediction in the set of predictions “Y” is compared to a respective ground truth, for example, from the ground truth data 122. At 210, based on the comparing, a loss value for each training sample in the first set of training data 118 is determined. For example, the predictions “Y” are then compared against their known ground-truths Ygt={y1gt, y2gt, . . . } (e.g., from ground truths 122) and a degree of mismatch between prediction and ground-truth is quantified using a so-called loss function “L”. As such, each sample (e.g., x1, x2 . . . ) from the training samples “X” has its own individual loss value {L(y1, y1gt), L(y2, y2gt), . . . }. Thus, each sample in the first set of training data 118 is associated with a loss value, where “L1” represents the set of loss values L1={L(M1(x1), y1gt), L(M1(x2), y2gt),} in the first set of training data 118.

With reference now to FIG. 3, a flowchart illustrating an exemplary method 300 for determining loss values for a subsequent ML model (e.g., the second ML model 112) using the original training data (e.g., the first set of training data 118) that was used to train the initial ML model (e.g., the first ML model 110) is provided. In some examples, the method 300 is executed or otherwise performed by or in association with a system such as system 100 of FIG. 1.

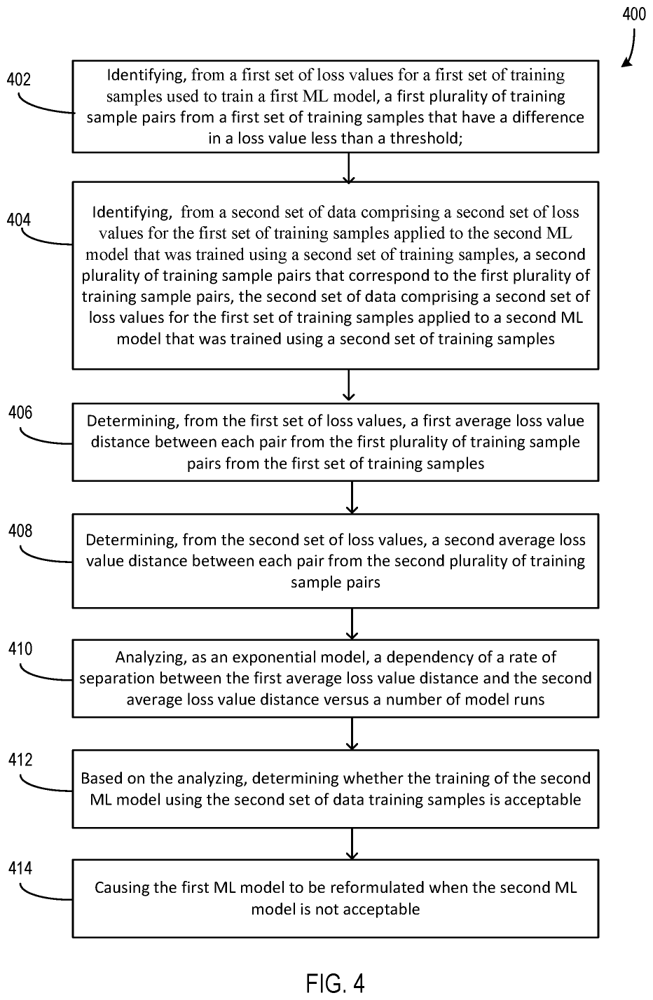

At 302, the first set of training samples are applied to the second ML model 112 as input. As explained above, the second ML model 112 was trained using the second set of training data/samples 120, and while loss values associated with the second set of training data/samples 120 are calculated during training of the second ML model 112 (e.g., similar to how the loss values for the first set of training data 118 being applied to the first ML model 110 are calculated and used as described in FIG. 2), loss values are now being calculated using the first set of training data 118 (e.g., the original/initial training data used to train the first/initial ML model, such as the first ML model 110). At 304, based on applying the first set of training data 118 to the second ML model 112, a set of predictions from the second ML model 112 is received/determined, wherein the set of predictions include a prediction corresponding to each training sample in the first set of training data/samples 118. At 306, each prediction in the set of predictions is compared to a respective ground truth from the ground truth data 122. At 308, based on the comparing, a loss value for each training sample in the first set of training samples is determined. As described in further detail below with respect to FIG. 4, these loss values are used to determine the stability of the data generation process (e.g., the stability of the second ML model 112). In addition, while the method 300 is applied to a single ML model (e.g., the second ML model 112), the method 300 would be applied to each ML model that stems from an original ML model (e.g., the first ML model 110). Thus, if there are ten ML models (e.g., an initial ML model was retrained 9 time with different training data times resulting in ten different ML models, the method 300 would be applied to each of the nine ML models that followed the original ML model.

With reference now to FIG. 4, a flowchart illustrating an exemplary method 400 for determining the stability of a data generation process is provided. In some examples, the method 400 is executed or otherwise performed by or in association with a system such as system 100 of FIG. 1.

At 402, a first plurality of training sample pairs from the first set of training samples that have a difference in a loss value (e.g., the lost value determined at step 210 in FIG. 2) less than a threshold are identified from a first set of loss values for the first ML model 110. As explained above, each sample in the first set of training data 118 is associated with a loss value. As used herein, “L1” represents the set of loss values L1={L(M1(x1), y1gt), L(M1(x2), y2gt), . . . } in the first set of training data 118. Thus, for each set of loss values (e.g., L1-Ln) all pairs of samples in the first set of loss values that are arbitrarily close to each other (in terms of loss values), for example, below a threshold are identified. For example, assume that samples xi and xj from the first set of training data 118 applied to the first ML model 110 are such that |L1(xi)−L1(xj)|<eps (where the threshold is eps=1e-4).

At 404, a second plurality of training sample pairs that correspond to the first plurality of training sample pairs are identified from a second set of data comprising a second set of loss values (e.g., the loss values determined at step 308 in FIG. 3) for the first set of training samples applied to the second ML model 112 that was trained using the second set of training data 120. In some examples, when the second ML model 112 is generated using the second set of training data 120, the first set of training data 118 (e.g., the original data training set) is also applied to the second ML model 112. Thus, from the first set of training data 118 applied to the second ML model 112, samples (e.g., x1, x2 . . . ) from the training samples “X” in the first set of training data 118 generates a new set of loss values and “L2” represents the second set of loss values L2={L(M2(x1), y1gt), L(M2(x2), y2gt), . . . }. Carrying on this procedure after “n” re-training iterations, we end up with “N” sets of loss values for the same samples from first set of training data 118.

At 406, a first average loss value distance between each pair from the first plurality of training sample pairs from the first set of training samples are determined from the first set of loss values, and at 408, a second average loss value distance between each pair from the second plurality of training sample pairs are determined from the second set of loss values. That is, for each set of loss values (e.g., L1-Ln), all pairs of samples that are arbitrarily close to each other (in terms of loss values) are identified. For example, all pairs of samples that are below a threshold are identified. In some examples the threshold his eps=1e-4, and samples xi and xj from the first set of training data 118 applied to the first ML model 110 are such that |L1(xi)−L1(xj)|<eps. Again, while the example described in FIG. 4 uses two ML models (e.g., the first ML model 110 and the second ML model 112), the number of ML models that may be monitored is represented as “k”, and thus, there may be any number of a plurality of ML models being monitored. Thus, in some examples, the average distance “d(k)” after “k” re-trainings is defined as follows:

$$d ( k ) = Avg \vert Lk ( xi ) - Lk ( xj ) \vert over all pairs ( i , j ) of samples such that \vert L 1 ( xi ) - L 1 ( xj ) \vert < eps .$$

At 410, a dependency of a rate of separation between the first average loss value distance and the second average loss value distance versus a number of model runs is analyzed as an exponential model. For example, the solving of “d(k)” is repeated for a range of values of “k” (for example k=1, 2, . . . 10) and a dependency of d(k) vs. k as an exponential model d(k)˜exp(k*lambda) where lambda is a parameter which is extracted from the data itself is analyzed. At 412, based on the analyzing, it is determined whether the training of the second ML model 112 using the second set of data training samples is acceptable, for example, it is determined whether the data generation process is stable. In some examples, when the value of lambda equal to or less than zero, it is determined that the data generating process is stable under the current ML formulation, and thus, a latest ML model (e.g., the second ML model 112 in this example or the K^{th} ML model 114 in other examples) is stable and standard model retraining strategies are enough to keep the second ML model 112 up to date, as well as address any potential data/concept drifts.

At 414, when the second ML model 112 is determined to not be stable/divergent, the second ML model 112 or the first ML model 110 is reformulated. In some examples, when lambda is greater than 0, it is determined that the data generating process is divergent and the standard model retraining strategies are not enough to keep the second ML model 112 up to date, and is not enough to address any potential data/concept drifts. In this case, an alert is raised indicating that model re-trainings are bound to be ultimately unsuccessful and that instead a new formulation of the second ML model 112 is needed. In some examples, the alert is presented to a user in graphical user interface. In some examples, the alert enables the user to reformulate the second ML model 112. In other examples, the alert disables the ability of a current ML model (e.g., the second ML model 112) to be retrained. In this example, the current ML model is still used to provide data until a new ML model is generated/trained based on the reformulation.

### Exemplary Operating Environment

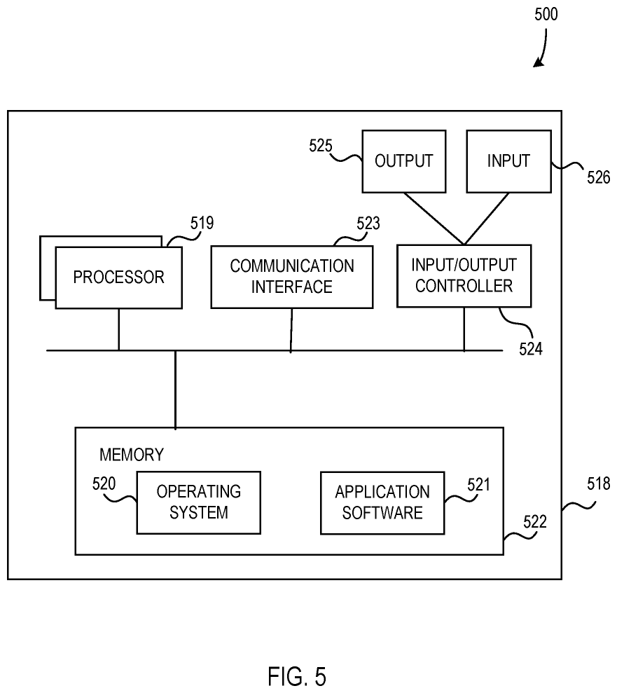

The present disclosure is operable with a computing apparatus according to an embodiment as a functional block diagram 500 in FIG. 5. In an example, components of a computing apparatus 518 are implemented as a part of an electronic device (e.g., an electronic device that either includes or is connected to the computing device 102) according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a memory comprising: computer readable media; a first set of data for a first machine learning (ML) model; and a second set of data for a second ML model, the first set of data comprising a first set of loss values for a first set of training samples used to train the first ML model, the second set of data comprising a second set of loss values for the first set of training samples applied to the second ML model that was trained using a second set of training samples; identifying, from the first set of loss values for the first ML model, a first plurality of training sample pairs from the first set of training samples that have a difference in a loss value less than a threshold; identifying, from the second set of data, a second plurality of training sample pairs that correspond to the first plurality of training sample pairs; determining, from the first set of loss values, a first average loss value distance between each pair from the first plurality of training sample pairs from the first set of training samples; determining, from the second set of loss values, a second average loss value distance between each pair from the second plurality of training sample pairs; analyzing, as an exponential model, a dependency of a rate of separation between the first average loss value distance and the second average loss value distance versus a number of model runs; based on the analyzing, determining whether the training of the second ML model using the second set of training samples is stable; and causing the first ML model to be reformulated when the second ML model is not stable.

An example computerized method comprises: identifying, from a first set of loss values for a first set of training samples used to train a first ML model, a first plurality of training sample pairs from a first set of training samples that have a difference in a loss value less than a threshold; identifying, from a second set of data comprising a second set of loss values for the first set of training samples applied to the second ML model that was trained using a second set of training samples, a second plurality of training sample pairs that correspond to the first plurality of training sample pairs, the second set of data comprising a second set of loss values for the first set of training samples applied to a second ML model that was trained using a second set of training samples; determining, from the first set of loss values, a first average loss value distance between each pair from the first plurality of training sample pairs from the first set of training samples; determining, from the second set of loss values, a second average loss value distance between each pair from the second plurality of training sample pairs; analyzing, as an exponential model, a dependency of a rate of separation between the first average loss value distance and the second average loss value distance versus a number of model runs; based on the analyzing, determining whether the training of the second ML model using the second set of data training samples is stable; and causing the first ML model to be reformulated when the second ML model is not stable.

One or more computer storage media having computer-executable instructions that, upon execution by a processor, cause the processor to perform the following: identifying, from a first set of loss values for a first set of training samples used to train a first ML model, a first plurality of training sample pairs from a first set of training samples that have a difference in a loss value less than a threshold; identifying, from a second set of data comprising a second set of loss values for the first set of training samples applied to the second ML model that was trained using a second set of training samples, a second plurality of training sample pairs that correspond to the first plurality of training sample pairs, the second set of data comprising a second set of loss values for the first set of training samples applied to a second ML model that was trained using a second set of training samples; determining, from the first set of loss values, a first average loss value distance between each pair from the first plurality of training sample pairs from the first set of training samples; determining, from the second set of loss values, a second average loss value distance between each pair from the second plurality of training sample pairs; analyzing, as an exponential model, a dependency of a rate of separation between the first average loss value distance and the second average loss value distance versus a number of model runs; based on the analyzing, determining whether the training of the second ML model using the second set of data training samples is stable; and causing the first ML model to be reformulated when the second ML model is not stable.

Alternatively, or in addition to the other examples described herein, examples include any combination of the following:
wherein the first set of loss values are determined by the following:
   receiving the first set of training samples;
   receiving ground truth data;
   applying the first set of training samples as input into the first ML model;
   receiving, based on the applying, a set of predictions from the first ML model, the set of predictions comprising a prediction corresponding to each training sample in the first set of training samples;
   comparing each prediction in the set of predictions to a respective ground truth from the ground truth data; and based on the comparing, determining a loss value for each training sample in the first set of training samples.
wherein the second set of loss values are determined by the following:
   receiving the first set of training samples;
   receiving ground truth data;
   applying the first set of training samples as input into the second ML model trained using the second set of training samples;
   receiving, based on the applying, a set of predictions from the second ML model, the set of predictions comprising a prediction corresponding to each training sample in the first set of training samples;
   comparing each prediction in the set of predictions to a respective ground truth from the ground truth data; and
   based on the comparing, determining a loss value for each training sample in the first set of training samples.
wherein the exponential model is d(k)˜exp(k*lambda), where “k” is the number of ML models, “d(k)” is an average loss value distance for an ML model, and lambda is a parameter is extracted from the data.
wherein d(k)=Avg|Lk(xi)−Lk(xj)|, wherein “L” is a loss value, “k” is the number of the ML model, “x” is the first set of training samples, and “i” and “j” are training sample pairs from the first set of training samples that have a difference in a loss value less than the threshold.
wherein when a value of lambda is less than or equal to zero, a current data generation process is stable and the training of the second ML model using the second set of training samples is stable; and wherein the value of lambda is greater than zero, the current data generation process is divergent and the training of the second ML model using the second set of training samples is not stable.
wherein causing the first ML model to be reformulated comprises issuing an alert to a user.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for based on the query, selecting a website; exemplary means for identifying a plurality of media on the website; exemplary means for based at least on the query, selecting a portion of the plurality of media on the website; exemplary means for extracting content from each of the selected portion of the plurality of media based on the query; exemplary means for generating semantic summaries of the extracted content; exemplary means for aggregating the semantic summaries into an aggregated semantic summary; and exemplary means for providing the aggregated semantic summary to the user.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for re-formulating a machine learning model, the system comprising:
a memory comprising: computer readable media; a first set of data for a first machine learning (ML) model; and a second set of data for a second ML model, the first set of data comprising a first set of loss values for a first set of training samples used to train the first ML model, the second set of data comprising a second set of loss values for the first set of training samples applied to the second ML model that was trained using a second set of training samples;
identifying, from the first set of loss values for the first ML model, a first plurality of training sample pairs from the first set of training samples that have a difference in a loss value less than a threshold;
identifying, from the second set of data, a second plurality of training sample pairs that correspond to the first plurality of training sample pairs;
determining, from the first set of loss values, a first average loss value distance between each pair from the first plurality of training sample pairs from the first set of training samples;
determining, from the second set of loss values, a second average loss value distance between each pair from the second plurality of training sample pairs;
analyzing, as an exponential model, a dependency of a rate of separation between the first average loss value distance and the second average loss value distance versus a number of model runs;
based on the analyzing, determining whether the training of the second ML model using the second set of training samples is stable; and
causing the first ML model to be reformulated when the second ML model is not stable.

2. The system of claim 1, wherein the first set of loss values are determined by the following:
receiving the first set of training samples;
receiving ground truth data;
applying the first set of training samples as input into the first ML model;
receiving, based on the applying, a set of predictions from the first ML model, the set of predictions comprising a prediction corresponding to each training sample in the first set of training samples;
comparing each prediction in the set of predictions to a respective ground truth from the ground truth data; and
based on the comparing, determining a loss value for each training sample in the first set of training samples.

3. The system of claim 1, wherein the second set of loss values are determined by the following:
receiving the first set of training samples;
receiving ground truth data;
applying the first set of training samples as input into the second ML model trained using the second set of training samples;
receiving, based on the applying, a set of predictions from the second ML model, the set of predictions comprising a prediction corresponding to each training sample in the first set of training samples;
comparing each prediction in the set of predictions to a respective ground truth from the ground truth data; and
based on the comparing, determining a loss value for each training sample in the first set of training samples.

4. The system of claim 1, wherein the exponential model is d(k)˜exp(k*lambda), where “k” is the number of ML models, “d(k)” is an average loss value distance for an ML model, and lambda is a parameter is extracted from the data.

5. The system of claim 4, wherein d(k)=Avg|Lk(xi)−Lk(xj)|, wherein “L” is a loss value, “k” is the number of the ML model, “x” is the first set of training samples, and “i” and “j” are training sample pairs from the first set of training samples that have a difference in a loss value less than the threshold.

6. The system of claim 4, wherein when a value of lambda is less than or equal to zero, a current data generation process is stable and the training of the second ML model using the second set of training samples is stable; and
wherein the value of lambda is greater than zero, the current data generation process is divergent and the training of the second ML model using the second set of training samples is not stable.

7. The system of claim 1, wherein causing the first ML model to be reformulated comprises issuing an alert to a user.

8. A computerized method comprising:
identifying, from a first set of loss values for a first set of training samples used to train a first ML model, a first plurality of training sample pairs from a first set of training samples that have a difference in a loss value less than a threshold;
identifying, from a second set of data comprising a second set of loss values for the first set of training samples applied to the second ML model that was trained using a second set of training samples, a second plurality of training sample pairs that correspond to the first plurality of training sample pairs, the second set of data comprising a second set of loss values for the first set of training samples applied to a second ML model that was trained using a second set of training samples;
determining, from the first set of loss values, a first average loss value distance between each pair from the first plurality of training sample pairs from the first set of training samples;
determining, from the second set of loss values, a second average loss value distance between each pair from the second plurality of training sample pairs;
analyzing, as an exponential model, a dependency of a rate of separation between the first average loss value distance and the second average loss value distance versus a number of model runs;
based on the analyzing, determining whether the training of the second ML model using the second set of data training samples is stable; and
causing the first ML model to be reformulated when the second ML model is not stable.

9. The computerized method of claim 8, further comprising determining the first set of loss values by:
receiving the first set of training samples;
receiving ground truth data;
applying the first set of training samples as input into the first ML model;
receiving, based on the applying, a set of predictions from the first ML model, the set of predictions comprising a prediction corresponding to each training sample in the first set of training samples;
comparing each prediction in the set of predictions to a respective ground truth from the ground truth data; and
based on the comparing, determining a loss value for each training sample in the first set of training samples.

10. The computerized method of claim 8, further comprising determining the second set of loss values by:
receiving the first set of training samples;
receiving ground truth data;
applying the first set of training samples as input into the second ML model trained using the second set of training samples;
receiving, based on the applying, a set of predictions from the second ML model, the set of predictions comprising a prediction corresponding to each training sample in the first set of training samples;
comparing each prediction in the set of predictions to a respective ground truth from the ground truth data; and
based on the comparing, determining a loss value for each training sample in the first set of training samples.

11. The computerized method of claim 8, wherein the exponential model is d(k)˜exp(k*lambda), where “k” is the number of ML models, “d(k)” is an average loss value distance for an ML model, and lambda is a parameter is extracted from the data.

12. The computerized method of claim 11, wherein d(k)=Avg|Lk(xi)−Lk(xj)|, wherein “L” is a loss value, “k” is the number of the ML model, “x” is the first set of training samples, and “i” and “j” are training sample pairs from the first set of training samples that have a difference in a loss value less than the threshold.

13. The computerized method of claim 11, wherein when a value of lambda is less than or equal to zero, a current data generation process is stable and the training of the second ML model using the second set of training samples is stable; and
wherein the value of lambda is greater than zero, the current data generation process is divergent and the training of the second ML model using the second set of training samples is not stable.

14. The computerized method of claim 8, wherein causing the first ML model to be reformulated comprises issuing an alert to a user.

15. A computer storage medium storing computer-executable instructions that, upon execution by a processor, cause the processor to perform the following:
identifying, from a first set of loss values for a first set of training samples used to train a first ML model, a first plurality of training sample pairs from a first set of training samples that have a difference in a loss value less than a threshold;
identifying, from a second set of data comprising a second set of loss values for the first set of training samples applied to the second ML model that was trained using a second set of training samples, a second plurality of training sample pairs that correspond to the first plurality of training sample pairs, the second set of data comprising a second set of loss values for the first set of training samples applied to a second ML model that was trained using a second set of training samples;
determining, from the first set of loss values, a first average loss value distance between each pair from the first plurality of training sample pairs from the first set of training samples;
determining, from the second set of loss values, a second average loss value distance between each pair from the second plurality of training sample pairs;
analyzing, as an exponential model, a dependency of a rate of separation between the first average loss value distance and the second average loss value distance versus a number of model runs;
based on the analyzing, determining whether the training of the second ML model using the second set of data training samples is stable; and
causing the first ML model to be reformulated when the second ML model is not stable.

16. The computer storage medium of claim 15, wherein the first set of loss values are determined by the following:
receiving the first set of training samples;
receiving ground truth data;
applying the first set of training samples as input into the first ML model;
receiving, based on the applying, a set of predictions from the first ML model, the set of predictions comprising a prediction corresponding to each training sample in the first set of training samples;
comparing each prediction in the set of predictions to a respective ground truth from the ground truth data; and
based on the comparing, determining a loss value for each training sample in the first set of training samples.

17. The computer storage medium of claim 15, wherein the second set of loss values are determined by the following:
receiving the first set of training samples;
receiving ground truth data;
applying the first set of training samples as input into the second ML model trained using the second set of training samples;
receiving, based on the applying, a set of predictions from the second ML model, the set of predictions comprising a prediction corresponding to each training sample in the first set of training samples;
comparing each prediction in the set of predictions to a respective ground truth from the ground truth data; and
based on the comparing, determining a loss value for each training sample in the first set of training samples.

18. The computer storage medium of claim 15, wherein the exponential model is d(k)˜exp(k*lambda), where “k” is the number of ML models, “d(k)” is an average loss value distance for an ML model, and lambda is a parameter is extracted from the data.

19. The computer storage medium of claim 18, wherein d(k)=Avg|Lk(xi)−Lk(xj)|, wherein “L” is a loss value, “k” is the number of the ML model, “x” is the first set of training samples, and “i” and “j” are training sample pairs from the first set of training samples that have a difference in a loss value less than the threshold.

20. The computer storage medium of claim 15, wherein when a value of lambda is less than or equal to zero, a current data generation process is stable and the training of the second ML model using the second set of training samples is stable; and
wherein the value of lambda is greater than zero, the current data generation process is divergent and the training of the second ML model using the second set of training samples is not stable.
